(19) United States
(12) Patent Application Publication
(10) Pub. No.: US 2026/0066483 A1
(43) Pub. Date: Mar. 5, 2026

(54) SECONDARY BATTERY

(71) Applicant: Samsung SDI Co., Ltd., Yongin-si (KR)

(72) Inventors: Dong Hyun KIM, Yongin-si (KR); Ye Jin SEO, Yongin-si (KR); Eun Jeong MOON, Yongin-si (KR)

(21) Appl. No.: 19/012,136

(22) Filed: Jan. 7, 2025

(30) Foreign Application Priority Data
Sep. 4, 2024 (KR) 10-2024-0119777

(51) Int. Cl. H01M 50/533; B60L 50/64; H01M 50/105; H01M 50/536

(52) U.S. Cl. CPC H01M 50/533; H01M 50/105; H01M 50/536; B60L 50/64; H01M 2220/20

(57) ABSTRACT

A secondary battery having improved reliability includes a case, an electrode assembly accommodated in the case and including an electrode tab, and a lead connected to the electrode tab, the electrode tab and the lead are coupled in a welding area, the welding area includes at least two or more bending areas, and a length of the electrode tab is greater than or approximately equal to the thickness of the electrode assembly.

### CROSS-REFERENCE TO THE RELATED APPLICATION

The present application claims priority to and the benefit of Korean Patent Application No. 10-2024-0119777, filed on Sep. 4, 2024, in the Korean Intellectual Property Office, the entire disclosure of which is incorporated herein by reference.

### BACKGROUND

### 1. Field

Embodiments relate to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments provide a secondary battery having improved reliability.

The secondary battery according to an embodiment comprises a case, an electrode assembly accommodated in the case and comprising an electrode tab, and a lead connected to the electrode tab, the electrode tab and the lead are coupled in a welding area, the welding area comprises at least two bending areas, and a length of the electrode tab is greater than or substantially equal to a thickness of the electrode assembly.

The length of the electrode tab may be approximately 1 to approximately 4 times the thickness of the electrode assembly.

A length of the welding area may be approximately 70% to approximately 85% of the length of the electrode tab.

A length of the welding area may be approximately 1 to approximately 3 times the thickness of the electrode assembly.

A height of the electrode tab may be less than or substantially equal to the thickness of the electrode assembly, and the height of the electrode tab is defined as a distance between a lowest point and a highest point.

The welding area may comprise a first bending region, a second bending region, and a third bending region, and one of the first bending region, the second bending region, or the third bending region is bent in a different direction from the other bending regions.

Curvatures of the first bending region, the second bending region, and the third bending region may be different.

The secondary battery may further comprise a protective layer on one surface of the electrode tab, and the protective layer may be in the welding area.

The protective layer may comprise a plurality of patterns spaced apart from each other.

The electrode tab may comprise a plurality of pattern parts each comprising a plurality of patterns, and the patterns may have a groove or hole shape.

The pattern part may be on an area corresponding to the bending area.

The electrode tab may comprise a plurality of holes in an area corresponding to the welding area, the lead may comprise a lower lead on a lower surface of the electrode tab and an upper lead on an upper surface of the electrode tab, and the lower lead and the upper lead may be connected.

A conductive material may be inside the hole, and the lower lead and the upper lead may be electrically connected by the conductive material.

One end of the lower lead may be coupled with one area of the upper lead.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view showing a secondary battery according to an embodiment.

FIG. 2 is a view depicting a connection of an electrode tab and a lead of the secondary battery according to one embodiment.

FIGS. 3 and 4 are views depicting the welding size according to the thickness of the secondary battery.

FIGS. 5 and 6 are side views of the secondary battery according to one embodiment.

FIG. 7 is a view depicting a manufacturing process of the electrode tab of the secondary battery according to one embodiment.

FIGS. 8 to 13 are views depicting the electrode tab of the secondary battery according to another embodiment.

FIG. 14 and FIG. 15 are perspective views showing a vehicle including battery packs according to an embodiment of the present disclosure.

FIG. 16 and FIG. 17 are a perspective view and a side view, respectively, of a vehicle including a battery pack according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, a secondary battery according to an embodiment will be described with reference to the drawings. The secondary battery may be classified into a cylindrical shape, a prismatic shape, a pouch shape, or a coin shape battery depending on its shape. The secondary battery described below may be applied to a pouch-type secondary battery.

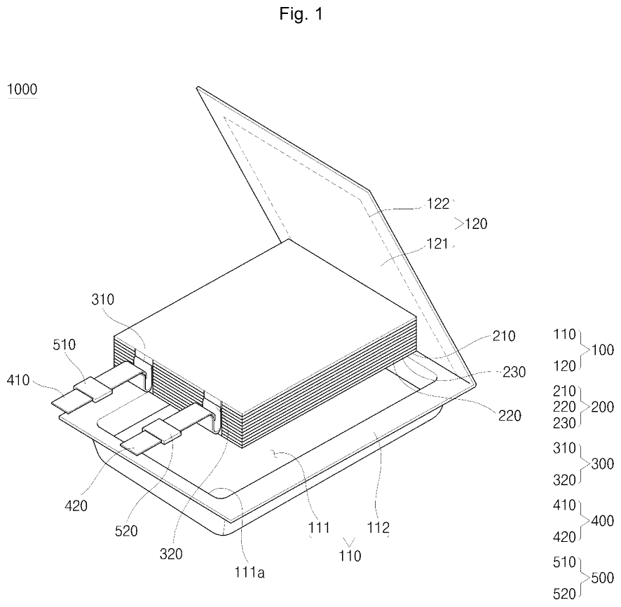

Referring to FIGS. 1 to 4, the secondary battery 1000 according to the embodiment may include a case 100 and an electrode assembly 200.

The case 100 may include an accommodation part 110 and a cap part 120. The accommodation part 110 and the cap part 120 may be connected to each other. The case 100 may be formed in a pouch shape.

The accommodation part 110 may include a concave part 111 and a first sealing region 112 extending around the concave part 111. The accommodation part 110 may include an accommodation space. In one or more embodiments, the accommodation part 110 may include an internal bottom surface and an inner side surface formed by the concave part 111. The accommodation space may be formed by the bottom surface and the inner side surface.

The first sealing region 112 may be at the edge of the accommodation part 110. A sealing layer may be on the first sealing region 112.

The cap part 120 may include a cover part 121 and a second sealing region 122.

The cover part 121 may cover the accommodation part 110. In one or more embodiments, the cover part 121 may cover the electrode assembly 200 accommodated in the accommodation part 110.

The second sealing region 122 may be at the edge (or periphery) of the cap part 120. The sealing layer may be on the second sealing region 122. The first sealing region 112 of the case 100 and the second sealing region 122 of the cap part 120 may overlap. In one or more embodiments, when the accommodation part 110 is covered by the cap part 120, the first sealing region 112 and the second sealing region 122 may face each other. Therefore, the accommodation part 110 and the cap part 120 may be coupled by the sealing layer.

The electrode assembly 200 may be accommodated in the case 100. In one or more embodiments, the electrode assembly 200 may be accommodated inside the accommodation space of the case 100. In one or more embodiments, the electrode assembly 200 may be accommodated inside the accommodation space together with the electrolyte.

In the drawing, one electrode assembly 200 is accommodated in the case 100. However, the embodiment is not limited thereto. In one or more embodiments, two or more electrode assemblies may be accommodated in the case.

The electrode assembly 200 may include a first electrode 210, a second electrode 220, and a separator 230. The electrode assembly 200 may be formed by winding or laminating the first electrode 210, the second electrode 220, and the separator 230. In one or more embodiments, the electrode assembly 200 may be a Z-stack electrode assembly in which the first electrode 210 and the second electrode 220 are on opposite sides of a separator 230 and are bent into a Z-stack.

The first electrode 210 may include a first electrode current collector and a first electrode active material layer on the first electrode current collector. The first electrode current collector may include a metal foil such as aluminum or an aluminum alloy. The first electrode active material layer may include a transition metal oxide. For example, the first electrode 210 may be a positive electrode.

The first electrode 210 may be connected to a first electrode tab 310. The first electrode active material layer is not on the first electrode tab 310. The first electrode tab 310 may be welded to an uncoated portion on the first electrode current collector where the first electrode active material layer is not provided. The first electrode tab 310 may be welded to the first electrode current collector. In one or more embodiments, the first electrode tab 310 may be integral with the first electrode current collector. For example, the first electrode current collector may include a first uncoated portion on which the first electrode active material layer is not provided. The first uncoated portion may be the first electrode tab 310. The first electrode tab 310 may include the same material as the first electrode current collector.

The second electrode 220 may include a second electrode current collector and a second electrode active material layer on the second electrode current collector. The second electrode current collector may include a metal foil such as copper, a copper alloy, nickel, or a nickel alloy. The second electrode active material layer may include graphite or carbon. For example, the second electrode 220 may be a negative electrode.

The second electrode 220 may be connected to a second electrode tab 320. The second electrode active material layer is not on the second electrode tab 320. The second electrode tab 320 may be welded to an uncoated portion on the second electrode current collector where the second electrode active material layer is not provided. The second electrode tab 320 may be welded to the second electrode current collector. In one or more embodiments, the second electrode tab 320 may be integral with the second electrode current collector. For example, the second electrode current collector may include a second uncoated portion on which the second electrode active material layer is not provided. The second uncoated portion may be the second electrode tab 320. The second electrode tab 320 may include the same material as the second electrode current collector.

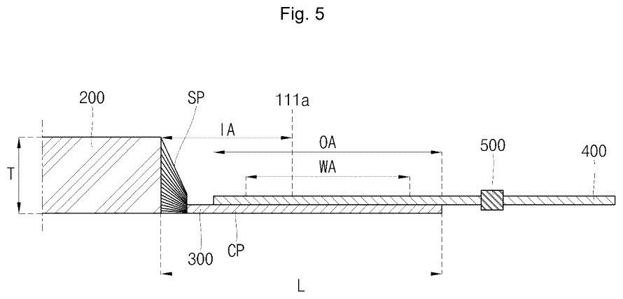

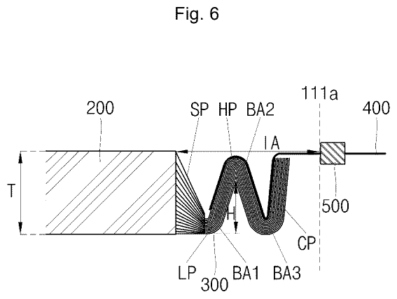

The first electrode tab 310 and the second electrode tab 320 may both be divided into a separation part SP and a coupling part CP. (See FIGS. 5 and 6) The separation part SP is a portion where a plurality of electrode tabs are separated from each other. The separation part SP is a portion where a plurality of electrode tabs are not welded together. The coupling part CP is a portion where the plurality of electrode tabs are in contact with each other. The coupling part CP is a portion where a plurality of electrode tabs are welded together.

The first electrode tab 310 and the second electrode tab 320 may each be connected to a lead. For example, the first electrode tab 310 may be connected to the first lead 410. The first electrode tab 310 may be connected to the first external terminal by the first lead 410. The second electrode tab 320 may be connected to the second lead 420. The second electrode tab 320 may be connected to the second external terminal by the second lead 420. The first lead 410 may include the same material as the first electrode tab 310, and the second lead 420 may include the same material as the second electrode tab 320.

Insulating layers 500 may be on the leads. For example, a first insulating layer 510 may be on the first lead 410. A second insulating layer 520 may be on the second lead 420. The lead 400 may be insulated from the case 100 by the insulating layer 500.

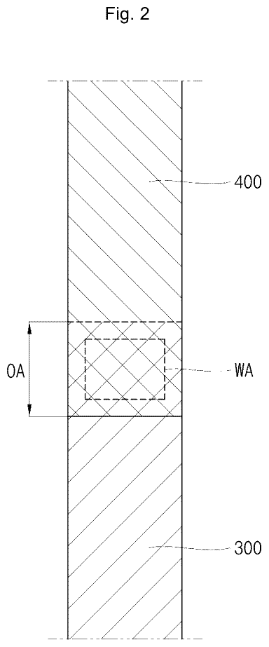

Referring to FIG. 2, the electrode tab 300 and the lead 400 may be coupled by welding.

In one or more embodiments, the electrode tab 300 and the lead 400 may overlap. Accordingly, the electrode tab 300 and the lead 400 may form an overlapping area OA. For example, the lead 400 may be on at least one of one surface or the other surface of the electrode tab 300.

The overlapping area OA may include a welding area WA. The welding area WA may be smaller than the overlapping area OA. The electrode tab 300 and the lead 400 may be welded together in the welding area WA. Accordingly, the electrode tab 300 and the lead 400 may be coupled to each other.

The sizes of the overlapping area and the welding area may vary depending on the size of the electrode assembly 200.

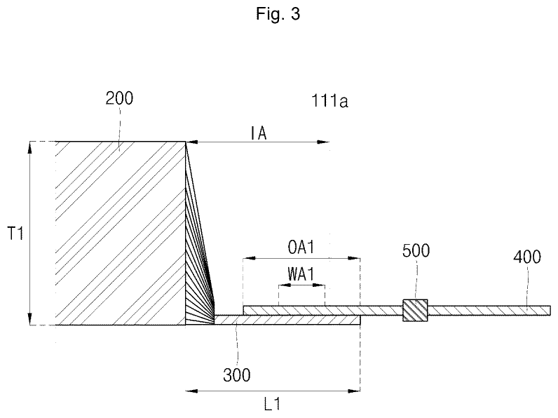

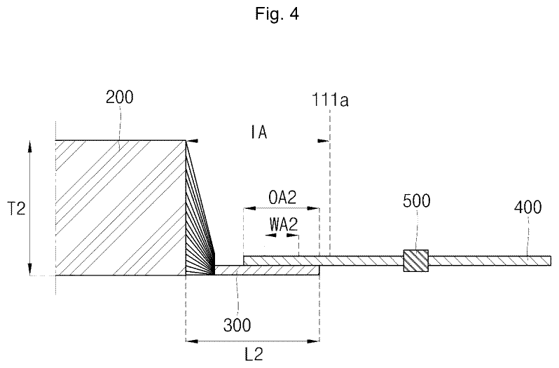

Referring to FIGS. 3 and 4, the size of the overlapping area OA and the welding area WA may vary depending on the thickness of the electrode assembly 200.

Referring to FIG. 3, the electrode assembly 200 may have a first thickness T1. The electrode tab 300 may have a first length L1. The first length L1 may depend on the first thickness T1. In one or more embodiments, the electrode tab 300 is inside the case 100. The electrode tab 300 may be bent. Accordingly, the size of the case 100 may be prevented from increasing due to the electrode tab 300. The electrode assembly 200 and the inner surface 111a of the accommodation part 110 are spaced apart. Accordingly, the case 100 may include a spaced area IA. The electrode tab 300 may be bent in the spaced area IA.

The bending height of the electrode tab 300 may depend on the thickness of the electrode assembly 200. In one or more embodiments, the bending height of the electrode tab 300 may be less than or substantially equal to the first thickness T1. When the bending height of the electrode tab 300 becomes greater than the first thickness T1, the size of the case 100 may increase. That is, the depth of the concave part 111 may increase to accommodate the electrode tab 300. Accordingly, the size of the secondary battery 1000 may increase. Accordingly, the first length L1 may be controlled to a length at which the bending height becomes less than or substantially equal to the first thickness T1.

Referring to FIG. 4, the electrode assembly 200 may have a second thickness T2. The second thickness T2 may be smaller than the first thickness T1. The electrode tab 300 may have a second length L2. The second length L2 may be controlled by the second thickness T2. In one or more embodiments, the bending height of the electrode tab 300 may be c less than or substantially equal to the second thickness T2. Accordingly, the second length L2 may be controlled to a length at which the bending height becomes less than or substantially equal to the second thickness T2.

Accordingly, the second length L2 may be smaller than the first length L1. That is, the length of the electrode tab 300 may be proportional to the thickness (e.g., T1 or T2) of the electrode assembly 200.

Referring to FIG. 3, the lead 400 may be on the electrode tab 300. Accordingly, the electrode tab 300 and the lead 400 may form the first overlapping area OA1. Referring to FIG. 4, the lead 400 may be on the electrode tab 300. Accordingly, the electrode tab 300 and the lead 400 may form the second overlapping area OA2.

The sizes of the first overlapping area OA1 and the second overlapping area OA2 are different. In one or more embodiments, the size of the first overlapping area OA1 may be larger than the size of the second overlapping area OA2. The first length L1 is greater than the second length L2. Therefore, the overlapping area of the electrode tab having the first length L1 and the lead may be larger than the overlapping area of the electrode tab having the second length L2 and the lead.

The welding area WA is formed inside the overlapping area OA. Therefore, the size of the welding area varies depending on the size of the overlapping area. In one or more embodiments, the size of the welding area is proportional to the size of the overlapping area. Referring to FIGS. 3 and 4, the size of the first welding area WA1 and the size of the second welding area WA2 may be different. In one or more embodiments, the size of the first welding area WA1 is greater than the size of the second welding area WA2. The first welding area WA1 is inside the first overlapping area OA1, and the second welding area WA2 is inside the second overlapping area OA2. Therefore, the first welding area WA1 is larger than the second welding area WA2.

Recently, a thin electrode assembly has been developed to reduce the size of the secondary battery. However, as described above, the size of the welding area varies depending on the thickness of the electrode assembly. When the thickness of the electrode assembly decreases, the length of the electrode tab decreases. Accordingly, the welding area of the electrode tab and the lead decreases. Accordingly, the bonding force between the electrode tab and the lead may decrease. Therefore, the welding part may be damaged by an external impact, causing a short circuit of the secondary battery.

The embodiment may solve the problems by controlling the length and shape of the electrode tab.

Referring to FIGS. 5 and 6, the secondary battery 1000 according to the embodiment may include the electrode assembly 200, the electrode tab 300, and the lead 400.

The electrode tab 300 may be connected to the electrode assembly 200. For example, the electrode tab 300 may be integral with the electrode assembly 200.

That is, the electrode tab 300 may be formed by the uncoated portion of the electrode assembly 200.

The lead 400 may be on at least one surface of the electrode tab 300. For example, a portion of the lead 400 may be on the upper surface of the electrode tab 300. Accordingly, the electrode tab 300 and the lead 400 may form an overlapping area OA.

The electrode tab 300 and the lead 400 may be coupled together. In one or more embodiments, the electrode tab 300 and the lead 400 may be coupled by welding. The welding may be performed within the overlapping area OA. Accordingly, a welding area WA may be inside the overlapping area OA.

The length L of the electrode tab 300 may be greater than or substantially equal to the thickness T of the electrode assembly 200. For example, the length L of the electrode tab 300 may be greater than the thickness T of the electrode assembly 200. For example, the length L may be approximately 1 to approximately 4 times, approximately 1.5 to approximately 3.5 times, or approximately 2 to approximately 3 times the thickness T.

The length of the welding area WA may be less than the length L of the electrode tab 300. The length of the welding area WA may be approximately 70% or more of the length L. For example, the length of the welding area WA may be approximately 70% to approximately 85%, approximately 73% to approximately 83%, or approximately 75% to approximately 80% of the length L.

The length of the welding area WA may be greater than or substantially equal to the thickness T of the electrode assembly 200. For example, the length of the welding area WA may be greater than the thickness T of the electrode assembly 200. For example, the length of the welding area WA may be approximately 1 to approximately 3 times, approximately 1.5 to approximately 2.7 times, or approximately 2 to approximately 2.5 times the thickness T.

That is, the length L of the electrode tab 300 may be greater than the thickness T of the electrode assembly 200. Accordingly, the length of the welding area WA may also be greater than the thickness T of the electrode assembly 200. Accordingly, the electrode tab 300 and the lead 400 may be stably coupled. Accordingly, the reliability of the secondary battery 1000 may be improved.

Referring to FIG. 6, the electrode tab 300 may be bent. In one or more embodiments, the welding area WA may be bent. Accordingly, the electrode tab 300 may be accommodated within the spaced area IA.

In one or more embodiments, the electrode tab 300 and the lead 400 may be bent. Accordingly, the electrode tab 300 and the lead 400 may be within the spaced area IA. Also, a portion of the lead 400 may be pulled out to the outside of the case 100.

The electrode tab 300 may include a plurality of bending areas. For example, the electrode tab 300 may include at least two bending areas. For example, the electrode tab 300 may include two or more or three or more bending areas.

For example, the electrode tab 300 may include a first bending area BA1, a second bending area BA2, and a third bending area BA3. The first bending area BA1, the second bending area BA2, and the third bending area BA3 may be in the coupling part CP. The first bending area BA1 may be the closest among the first bending area BA1, the second bending area BA2, and the third bending area BA3 to the separation part SP. That is, the first bending area BA1 may be the first bending area of the electrode tab 300.

The third bending area BA3 may be farthest among the first bending area BA1, the second bending area BA2, and the third bending area BA3 from the separation part SP. That is, the third bending area BA3 may be an area where the electrode tab 300 is bent last.

The second bending area BA2 may be between the first bending area BA1 and the third bending area BA3.

The electrode tab 300 may have a set height H. The height H of the electrode tab 300 may be defined as the distance from the lowest point LP to the highest point HP of the electrode tab 300.

The height H of the electrode tab 300 may be less than or substantially equal to the thickness T of the electrode assembly. For example, the height H of the electrode tab 300 may be smaller than the thickness T of the electrode assembly. Accordingly, the thickness of the case 100 may be prevented from increasing by the electrode tab 300.

The first bending area BA1, the second bending area BA2, and the third bending area BA3 may have a set curvature. For example, the curvature of the bending areas BA1, BA2, and BA3 may vary depending on the thickness of the electrode assembly 200. In one or more embodiments, the bending areas BA1, BA2, and BA3 may have a curvature such that the height of the electrode tab may be less than or substantially equal to the thickness of the electrode assembly 200. In one or more embodiments, the curvatures of the bending areas BA1, BA2, and BA3 may be the same or similar. In one or more embodiments, the curvatures of the bending areas BA1, BA2, and BA3 may be different.

The bending directions of the bending areas BA1, BA2, and BA3 may be different. For example, the bending directions of at least one of the first bending area BA1, the second bending area BA2, and the third bending area BA3 may be different. For example, the first bending area BA1 and the third bending area BA3 may be bent in a counterclockwise direction, and the second bending area BA2 may be bent in a clockwise direction.

The electrode tab 300 and the lead 400 may be bent in various ways.

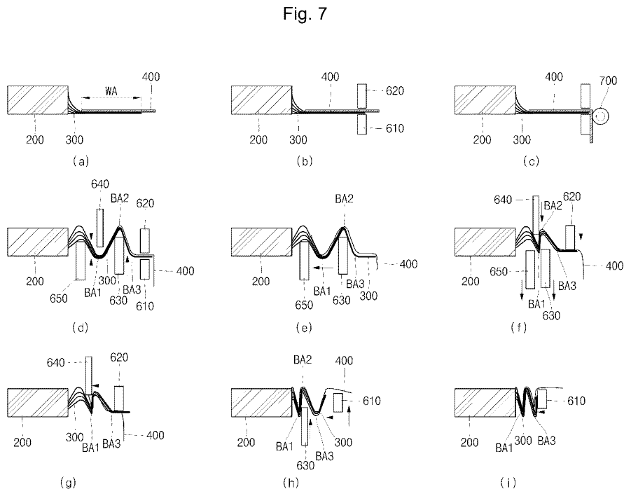

FIG. 7 is a view illustrating an embodiment of a method for bending the electrode tab 300 and the lead 400. Referring to FIG. 7, the electrode tab 300 and the lead 400 may be bent using a plurality of jigs and rollers.

Referring to FIG. 7 (a), the electrode tab 300 and the lead 400 may be welded. Accordingly, the welding area WA may be formed. As described above, the electrode tab 300 can be formed to a set length. In one or more embodiments, the length of the electrode tab 300 may be greater than the thickness of the electrode assembly 200. Therefore, the electrode tab 300 and the lead 400 may be welded in a welding area of sufficient size.

Referring to FIG. 7 (b), the electrode tab 300 and the lead 400 may be fixed by a first jig 610 and a second jig 620. The first jig 610 may be under the electrode tab 300, and the second jig 620 may be on (above) the electrode tab 300. The first jig 610 and the second jig 620 may be tab fixing jigs.

Referring to FIG. 7 (c), the lead 400 may be bent. In one or more embodiments, the lead 400 may be bent in one direction (e.g., downward) by the roller 700. At this time, the electrode tab 300 is not bent, and only the lead 400 may be bent. That is, the non-welded part of the lead 400 may be bent.

Referring to FIG. 7 (d), the electrode tab 300 and the lead 400 may be bent. In one or more embodiments, the welding area WA can be bent. In one or more embodiments, the welding area WA may be bent by a third jig 630, a fourth jig 640, and a fifth jig 650. The third jig 630 may be under the welding area, and the fourth jig 640 may be on (above) the welding area. In a state where the electrode tab 300 is fixed by the first jig 610 and the second jig 620, the third jig 630 may move upward, and the fourth jig 640 may move downward. Accordingly, the welding area may be bent. For example, the welding area may be bent in the first direction by the third jig 630 and in the second direction by the fourth jig 640. The fifth jig 650 may be under the separation part SP. The fifth jig 650 may guide the position of the separation part SP when the third jig 630 and the fourth jig 640 move. Accordingly, the first bending area BA1, the second bending area BA2, and the third bending area BA3 may be formed.

Referring to FIG. 7 (e), the first jig 610 may be moved downward, and the second jig 620 and the fourth jig 640 may be moved upward away from the electrode tab 300 and the lead 400. Next, the third jig 630 may be moved toward the fifth jig 650. Accordingly, the curvature of the first bending area BA1 may be controlled. That is, the curvature of the first bending area BA1 may be increased.

Referring to FIG. 7 (f), the third jig 630 and the fifth jig 650 are moved downward. Next, the second jig 620 and the fourth jig 640 are moved downward away from the electrode tab 300 and the lead 400.

Referring to FIG. 7 (g), the second jig 620 may be moved toward the fourth jig 640. Accordingly, the curvature of the second bending area BA2 may be controlled. That is, the curvature of the second bending area BA2 may be increased.

Referring to FIG. 7 (h), the first jig 610 and the third jig 630 move in an upward direction. Then, the first jig 610 may move toward the third jig 630. Accordingly, the curvature of the third bending area BA3 may be controlled. That is, the curvature of the third bending area BA3 may be increased.

Referring to FIG. 7 (i), the first jig 610 may move toward the electrode assembly 200. Accordingly, the curvatures of the first bending area BA1, the second bending area BA2, and the third bending area BA3 may all be controlled. That is, the curvatures of the bending areas may be increased. Accordingly, the height of the welding area may be controlled to be less than or substantially equal to the thickness of the electrode assembly.

The secondary battery according to the embodiment includes the electrode tab and the lead. The electrode tab and the lead are welded by the welding area.

The electrode tab is formed to a set length. In one or more embodiments, the length of the electrode tab may be greater than or substantially equal to the thickness of the electrode assembly. Accordingly, the size of the welding area may be sufficiently achieved. Accordingly, the bonding strength of the electrode tab and the lead may be increased.

The welding area may be bent. In one or more embodiments, the welding area may include at least two bending regions. Accordingly, the height of the welding area may be controlled. In one or more embodiments, the height of the welding area may be controlled to be less than or substantially equal to the thickness of the electrode assembly. Accordingly, the thickness of the case may be prevented from increasing by the welding region.

Accordingly, the secondary battery according to the embodiment may have a small size while improving the bonding strength of the welded part. Accordingly, the secondary battery according to the embodiment may have a compact size while improving reliability.

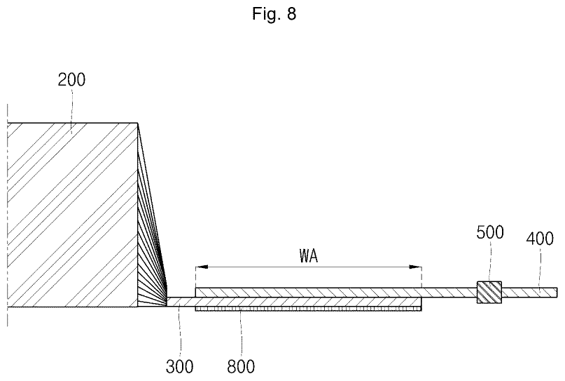

Hereinafter, the secondary battery according to another embodiment will be described with reference to FIGS. 8 to 13.

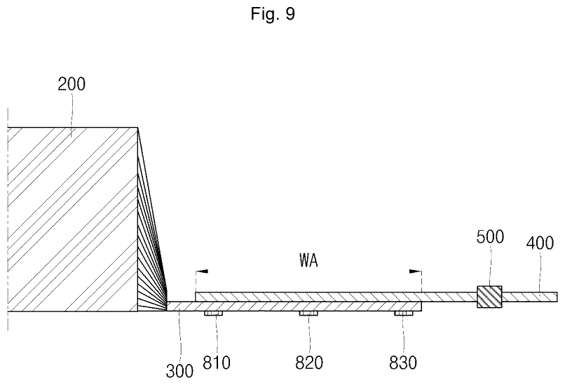

Referring to FIGS. 8 and 9, the secondary battery according to another embodiment may further include a protective layer 800. The protective layer 800 may be on the electrode tab 300. For example, the protective layer 800 may directly or indirectly contact the electrode tab 300.

The protective layer 800 may be on the welding area WA. Therefore, the protective layer 800 may be on the bending area of the welding area WA. Therefore, the welding area WA may be protected by the protective layer 800. In one or more embodiments, the welding area WA includes a plurality of bending areas. Stress may be generated in the welding area due to the bending areas. Accordingly, cracks may occur in the welding area due to the stress. Accordingly, welding characteristics of the electrode tab 300 and the lead may be reduced. Accordingly, a short circuit of the electrodes may occur. Accordingly, reliability of the secondary battery may be reduced.

The protective layer 800 may include resin or metal. The protective layer 800 may include an elastic material. The thickness of the protective layer 800 may be smaller than the thickness of the electrode tab 300 and the lead 400.

The welding area may be protected by the protective layer 800. In one or more embodiments, when the welding area is bent, it is possible to reduce or prevent cracks from being formed in the welding area. That is, the protective layer 800 may be a crack prevention layer.

The protective layer 800 may extend in one direction along the welding area WA. In one or more embodiments, the protective layer 800 may include a plurality of patterns. For example, referring to FIG. 9, the protective layer 800 may include a first protective layer 810, a second protective layer 820, and a third protective layer 830. The first protective layer 810, the second protective layer 820, and the third protective layer 830 may be spaced apart from each other.

The protective layer 800 may be formed with a plurality of patterns. Therefore, the space for forming the protective layer 800 may be reduced, and the patterns may serve as alignment marks. That is, when bending the welding area, the area where the protective layer 800 is provided may be bent. Therefore, the welding area may be bent at a desired position.

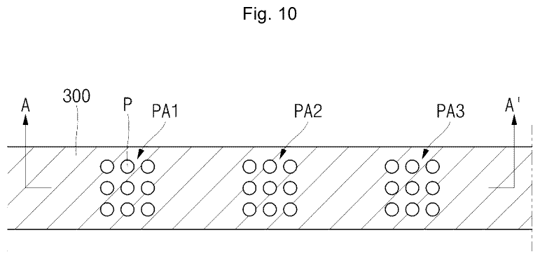

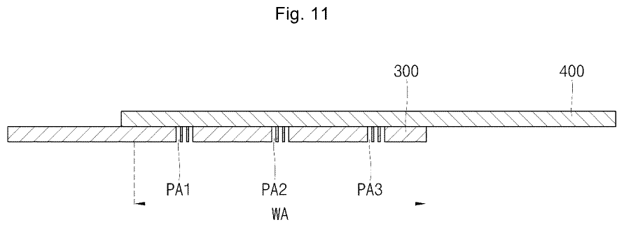

Referring to FIGS. 10 and 11, the electrode tab 300 may include a pattern part. The pattern part may be formed with a plurality of patterns. The pattern may be a hole or a groove. That is, the pattern may be a hole penetrating one surface and the other surface of the electrode tab. In one or more embodiments, the pattern may be a groove formed on one surface or the other surface of the electrode tab.

The electrode tab 300 may include a plurality of pattern parts. For example, the pattern part may include a first pattern part PA1, a second pattern part PA2, and a third pattern part PA3. The pattern parts may be formed in an area corresponding to the welding area WA. That is, the pattern parts PA1, PA2, and PA3 may overlap the welding area WA.

As described above, the welding area WA includes a plurality of bending areas. Stress may be generated in the welding area by the bending areas. Accordingly, cracks may occur in the welding area due to the stress.

The stress may be reduced by the pattern part. In one or more embodiments, the welding area may be bent in an area corresponding to the pattern part. Accordingly, the bending areas may include a plurality of patterns. The stress of the bending area may be distributed by the pattern. Therefore, cracks in the bending area may be reduced or prevented.

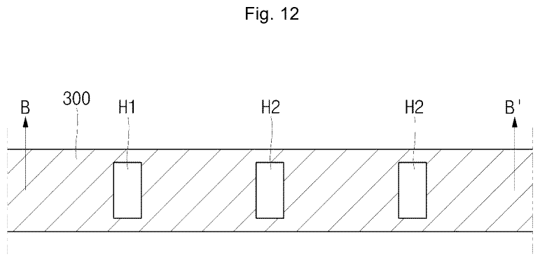

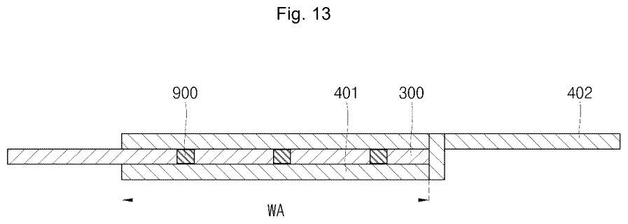

Referring to FIGS. 12 and 13, the electrode tab 300 may include at least one hole. The hole may be inside the electrode tab 300. The hole may include a plurality of holes. For example, the hole may include a first hole H1, a second hole H2, and a third hole H3. The holes may be formed in an area corresponding to the welding area WA. That is, the one or more holes may overlap the welding area WA.

The lead 400 may include a lower lead 401 and an upper lead 402. That is, at least one of the first lead 410 and the second lead 420 may include the lower lead 401 and the upper lead 402.

The lower lead 401 may be on the lower surface of the electrode tab 300. The upper lead 402 may be on the upper surface of the electrode tab 300.

The lower lead 401 and the upper lead 402 may be connected to each other. The inside of the one or more holes (e.g., H1, H2, and H3) in the electrode tab 300 may be filled with a conductive material 900. The lower lead 401 and the upper lead 402 may be electrically connected by the conductive material 900.

One end of the lower lead 401 may be connected to the upper lead 402. In one or more embodiments, one end of the lower lead 401 may be welded with one area of the upper lead 402. Accordingly, the lower lead 401 and the upper lead 402 may be coupled to each other.

As described above, the welding area WA includes a plurality of bending areas (e.g., BA1, BA2, and BA3). Stress may occur in the welding area WA due to the bending areas. Accordingly, cracks may occur in the welding area due to the stress.

The lead includes a plurality of leads on the upper and lower surfaces of the electrode tab, and the plurality of leads are electrically connected. Therefore, even if any one of the plurality of leads is short-circuited due to stress, the electrodes are not short-circuited. Therefore, the reliability of the secondary battery 1000 may be improved.

The secondary battery 1000 according to one embodiment may form a battery module. In one or more embodiments, the battery module may include a plurality of secondary batteries and a bus bar. The bus bar may connect the secondary batteries in at least one of a series or a parallel manner.

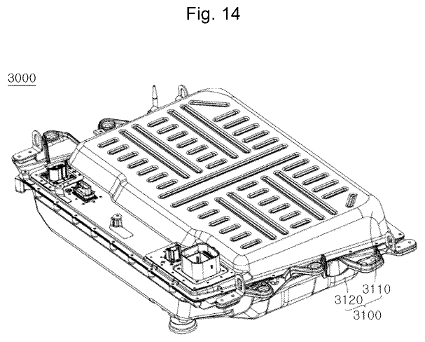

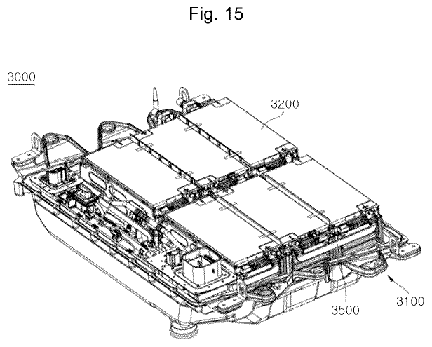

FIGS. 14 and 15 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

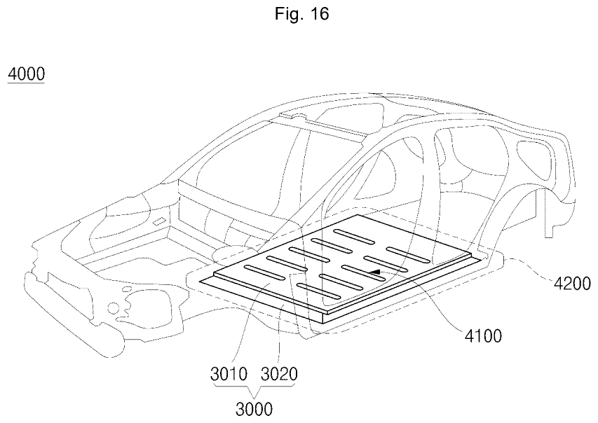

In FIG. 16, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle

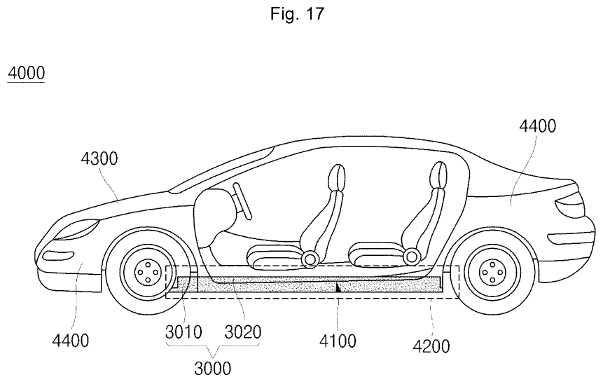

In FIG. 17, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure as claimed in the following claims.

What is claimed is:

1. A secondary battery comprising:
a case;
an electrode assembly accommodated in the case, the electrode assembly comprising an electrode tab; and
a lead connected to the electrode tab,
wherein the electrode tab and the lead are coupled in a welding area,
wherein the welding area comprises at least two bending areas, and
wherein a length of the electrode tab is greater than or substantially equal to a thickness of the electrode assembly.

2. The secondary battery as claimed in claim 1, wherein the length of the electrode tab is approximately 1 to approximately 4 times the thickness of the electrode assembly.

3. The secondary battery as claimed in claim 2, wherein a length of the welding area is approximately 70% to approximately 85% of the length of the electrode tab.

4. The secondary battery as claimed in claim 2, wherein a length of the welding area is approximately 1 to approximately 3 times the thickness of the electrode assembly.

5. The secondary battery as claimed in claim 1, wherein a height of the electrode tab is less than or approximately equal to the thickness of the electrode assembly, and
wherein the height of the electrode tab is defined as a distance between a lowest point and a highest point.

6. The secondary battery as claimed in claim 1, wherein the welding area comprises a first bending region, a second bending region, and a third bending region, and
wherein one of the first bending region, the second bending region, or the third bending region is bent in a different direction than others of the first bending region, the second bending region, or the third bending region.

7. The secondary battery as claimed in claim 6, wherein curvatures of the first bending region, the second bending region, and the third bending region are different.

8. The secondary battery as claimed in claim 1, further comprising a protective layer on one surface of the electrode tab, and
wherein the protective layer is on the welding area.

9. The secondary battery as claimed in claim 8, wherein the protective layer comprises a plurality of patterns spaced apart from each other.

10. The secondary battery as claimed in claim 1, wherein the electrode tab comprises a plurality of pattern parts,
wherein the plurality of pattern parts comprises a plurality of patterns, and
wherein the plurality of patterns have a groove or hole shape.

11. The secondary battery as claimed in claim 10, wherein the plurality of pattern parts is on an area corresponding to the bending area.

12. The secondary battery as claimed in claim 1, wherein the electrode tab comprises a plurality of holes,
wherein the plurality of holes is in an area corresponding to the welding area,
wherein the lead comprises a lower lead on a lower surface of the electrode tab and an upper lead on an upper surface of the electrode tab, and
wherein the lower lead and the upper lead are connected to each other.

13. The secondary battery as claimed in claim 12, further comprising a conductive material inside the plurality of holes,
wherein the lower lead and the upper lead are electrically connected by the conductive material.

14. The secondary battery as claimed in claim 12, wherein one end of the lower lead is coupled with one area of the upper lead.

15. The secondary battery as claimed in claim 13, wherein one end of the lower lead is coupled with one area of the upper lead.
